(19) United States
(12) Patent Application Publication
(10) Pub. No.: US 2005/0219360 A1
(43) Pub. Date: Oct. 6, 2005

(54) Method and apparatus for biometric access control with fully integrated digital video storage and retrieval

(76) Inventors: Francis John Cusack, Groton, MA (US); Frank Johnathan Davies, Pepperell, MA (US)

Correspondence Address: FRANCIS CUSACK, 174 DJCK POND DRIVE, GROTON, MA, 01450, US

(21) Appl. No.: 11/097,766

(22) Filed: Apr. 2, 2005

Related U.S. Application Data
(60) Provisional application No. 60/559,067, filed on Apr. 5, 2004.

(51) Int. Cl. H04N 7/18

(52) U.S. Cl. 348/156; 382/115; 340/5.52

(57) ABSTRACT

This invention details a system that combines the traditional security systems of access control and recorded video surveillance, and adds the essential layer of biometrics for non-reputable verification. Furthermore, this invention constitutes a true integration of these key security components, and in turn represents a system value proposition that far exceeds that of the individual components alone particularly in support of post event investigations.

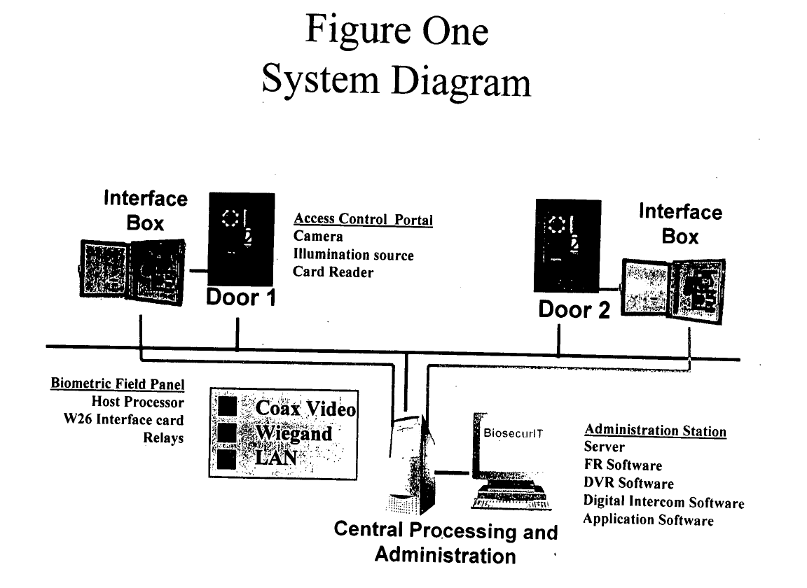

### REFERENCE TO RELATED APPLICATIONS

This application is based on, claims the benefit of the filing date of, and incorporates by reference, the provisional patent application Ser. No. 60/559,067 filed on Apr. 5, 2004.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### BACKGROUND OF THE INVENTION

The security market has historically lagged behind computing and communications technology developments. However, recent events have driven up the priority on security in general, and access control specifically. The two worlds of IT and security are now touching, and the security industry is finally getting the technology infusion that customers demand, and integrators desire to differentiate their product offerings. For high security access points, the traditional security pillars of CCTV, intercom and access control have historically coexisted as components of a fragmented system, using primarily analog signals, with only crude interfaces that don't allow for exploiting the power of proper system integration.

Biometrics will likely play an important role in the security industry as the only means to ensure automated non-reputable access control. The prevailing wisdom within the security community is that facial recognition (FR) will be featured prominently in the growth and maturity of access control market. There is a need for the security of biometric access control, the low ownership cost and reliability of digital video based CCTV system, and a seamless integration between the two to enable more effective post event investigation.

### BRIEF SUMMARY OF INVENTION

This invention is a user friendly, highly accurate and non-intrusive biometric access control and surveillance system that may operate in a stand-alone mode or as an adjunct to a conventional non-biometric access control system. It will leverage the innate advantages of face recognition over alternative biometrics, such as storing a high quality facial video record for each access attempt and potentially avoiding all physical contact (when used in conjunction with a proximity card).

This invention brings together the key components in an integrated system solution. Traditional CCTV storage requirements are addressed by a Digital Video Recorder (DVR), biometric requirements are address by primarily facial recognition technology with provisions for alternative or additional biometrics, and an intercom (either analogy or digital) is integrated tightly with both of these features.

The required hardware at the access point will be the Access Control Portal (ACP) designed to integrate all the hardware components necessary to consistently capture facial images suitable for automated recognition. The camera may be networked to a central server, Security Office or Human Resource central database. As an employee's PIN is presented, the system will compare his/her facial features with those stored in a (local or remote) database. If the features match entrance will be approved. If there were a question about identity, the individual may be subjected to a secondary biometric test (if such an option is present), such as voice or fingerprint recognition. While slower than facial recognition, fingerprints may be used to conduct a secondary biometric test against information stored either on an access card or in the database. If the secondary information is confirmed entrance will be approved. If the second test also fails, the individual will be denied access and the access attempt data will be marked accordingly for Administrator review. Furthermore, upon a failed access attempt, the system will instantiate an exception handling routine that will notify the Administrator in real time, and automatically send live video from the portal to the Administrator's terminal. Now the Administrator can see the person attempting access, communicate via integrated intercom, and compare the person's live facial image to one displayed from the database. In this fashion, exceptions may be handled quickly and with complete security.

### BRIEF DESCRIPTION OF THE DRAWINGS

Figure One System Diagram

Access Control Portal (ACP) consists of camera for surveillance and face recognition, integral illumination source and may include integral card reader.

Biometric Field Panel: consists of processor to support biometric verification, wiegand to ASCII converter board, I/O such as relays control of door switch, solenoid and other typical door peripherals.

Administrator's Station: consists of processor, face recognition software, digital video recording software, and application to support communication between the two, enrollment, audio, video and data communication with each portal and audio, video and data queries for investigative activity.

### DETAILED DESCRIPTION AND PREFERRED EMBODIMENT OF THE INVENTION

This invention may either be a self-contained stand alone solution or interface to a non-biometric access control system. The solution employs a locally embedded processor at each portal that sends communicates with central server. The invention is comprised of a portal unit that contains imaging hardware, biometric software, and whatever hardware and software is necessary for video and voice compression and transmission. Hardware platforms may include the PC or a purpose built processor; operating systems include Windows, Linux or embedded purpose built software. The portal unit will be compatible with reading in PIN data from a keypad, proximity card, magnetic stripe card or smart card. The central server will integrate DVR and biometric control functions into a single platform, and interface to legacy access control systems.

Access Control Portal (ACP)

The ACP unit will consist of a camera and card reader. It is envisioned that a microphone and speaker will also be an integral part of the unit to facilitate two way voice communications with the central server Operator. The hardware at the access point is designed to integrate all the hardware components necessary to consistently capture images suitable for automated recognition. The camera video will be connected back to the Biometric Field Panel via coaxial cable. As an employee's PIN is presented, the system will compare his/her facial features with those stored in a database resident at the Biometric Field Panel. If the features match entrance will be approved, and actuated via relays. If there were a question about identity, the individual may be subjected to a secondary biometric test or put in audio and video communication with the Operator at the Administration Station.

The (door side) user interface consists of audio (intercom) and visual (LEDs) queues only. The user interface will be ergonomic and intuitive. The user shall stand arm's length from the imaging system to present the PIN. Any illumination projected onto the user will consist of a comfortable and eye safe spectrum and intensity.

The imaging subsystem shall be mounted at a comfortable height, and the camera shall image as close to normal (object plane parallel with the face) as possible to eliminate inconsistent and uncomfortable pose requirements. The user will receive feedback of a successful or failed access attempt in the form of audio or visual queues (or both).

Administrators Terminal

The Administrator's terminal will facilitate enrollment of the employee's demographic and biometric data. The Administrator's terminal will also give the Administrator the ability to review photo enrollments, access log data, video sequences via direct query on door, time and date, and selectively control other video inputs to the server. The video server selection will allow full configuration of the video storage compression techniques, video motion detection by input, selectable control signal to other legacy equipment for site control, full control over pan/tilt/zoom/iris controllable video equipment also driven by the Server system.

As we know from our experience, while facial recognition has distinct advantages for access control, there will be a number of sites (namely outdoor) where today's face recognition technology is not viable. Therefore, each access point should utilize facial recognition biometric verification as well as have a seamless exception handling process. While the primary (automated) face check could be adjusted according to the environment, the secondary check may be achieved manually by the Operator studying the Administrator's display to compare adjacent images of live video from the door to the stored facial image from the database.

Biometric Field Panel (BFP)

It may be necessary to employ an interface field panel to decipher the analog Wiegand signal and make it compatible with the LAN prior to forwarding the data to the server. This panel may also digitize the analog audio signals for propagation through the intranet. The BFP will house a processor to run local face recognition software, support communication with the Administration Station, and all the door peripherals such as door switch, solenoid, REX pass back, etc.

Operation

In the preferred embodiment a high performance embedded processor manages biometric signal acquisition, template generation and matching locally at the BFP. The two most complementary biometrics for access control are face recognition and live scan fingerprint identification. The product can be configured to operate with just one biometric, both biometrics, as a conventional non-biometric input device using just a card or PIN, or any combination thereof. The system can be operated in either a stand alone or networked configuration.

Beyond the biometric layer, the invention emulates the functions of several conventional security subsystems that are highly desirable to have at a high security portal, and bundles them together in a low cost and attractive form factor. With a proprietary purpose built processor integral to the BFP, the only signal interface necessary is a LAN cable, which vastly simplifies installation and thereby lowers costs. Alternatively, traditional signals may be run from the BFP to a central processor.

By virtue of having a high quality camera within the ACP, the invention is capable of fulfilling digital video CCTV requirements with “facial recognition” compatible imagery. Compressed digital video is streamed from the BFP over the LAN back to the Administrator's terminal where it affords the Guard the ability to see real time video of the area around the portal.

This video may be stored on board the Administrator Station or a separate video server, without the need for additional digitization (ADCs).

A two-way voice capability emulates an intercom subsystem, and puts the Guard in direct audio contact with personnel at the portal. This is particularly helpful when working through access attempt exception handling and manual authentication. The ACU features a built in microphone and speaker and, may use “voice over IP” to digitize the audio for transmission and reception over the LAN.

The ACP also emulates a conventional access control system. Built into the front of the ACP is either a numeric keypad, or an RFID receiver, which takes in the user's authorization code prior to subjecting the user to a biometric verification. If the user passes the biometric test, the ACP may generate a valid wiegand 26-bit signal and pass it onto the conventional (or non-biometric) access control system. The ACP is thereby completely compatible with legacy access control systems, and can be retrofitted at portals seamlessly. Alternative means for simple integration will also be readily apparent to those skilled in the art.

Since it is IP based, authorized security managers with access to a browser can remotely review logs or even observe real time digital video of any portal within their charge. Enabling the Guard to remotely view and communicate with users through high quality digital video and audio, thereby emulating systems such as IPHONE, enhances security. A high quality (standardized and digitized) video record is created and stored for every access attempt to support event interrogations and non-repudiation claims.

1. A security solution that combines the functionality of;
a. Biometric physical access control (such as facial, voice, finger, hand or iris recognition)
b. Digital video surveillance recording and playback
c. Audio intercom

2. The security system of claim one that consist of
a. An access control portal unit that integrates a camera, light source and PIN input device
i. Camera of claim 2a is for capturing the facial image of user attempting portal access, a speaker and microphone for voice communication, and a PIN input device (e.g. RF proximity, bar code, magnetic stripe, etc).
ii. Camera of claim 2a is for facilitating video surveillance of the area around the door
b. A biometric field panel that takes video from the access control portal and runs face recognition algorithms to automatically verify the identity of the person requesting access through portal.
i. The biometric field panel in claim 2b also facilitates communication with Administrator Terminal
ii. The biometric field panel in claim 2b also facilitates communication and actuation of door peripherals such as but not limited to door switch, door solenoid, motion sensor, pass-back, etc.
c. An Administration Station the communicates with the biometric field panel via audio, video and data signals
i. The station of claim 2c facilitates enrollment and management of demographic, audio, video and other data for each user.
ii. The station of claim 2c facilitates queries of access control and video data in support of investigations.
iii. The images or video captured at either enrollment or the access control portal may be used for man-in-the-loop review consistent with DVR operation
iv. Voice data from claim 2c may be used for audio communication between the Administrator and the door area consistent with intercom operation
v. Voice data from claim 2c may be used for automated speech and voice recognition.
d. A digital video recorder which includes selectable and programmable video compression, storage and retrieval.
i. The digital video recorder may be integral with the Administration Station of claim 2c, or may a separate piece of equipment in communication with the Administration Station of claim 2c.
ii. The digital video recorder of claim 2d may include video motion detection, pan/tilt/zoom and iris control, alarms, video based surveillance algorithms and other software algorithms consistent with commercial digital video recorders.
